(19) United States
(12) Patent Application Publication
(10) Pub. No.: US 2020/0251752 A1
(43) Pub. Date: Aug. 6, 2020

(54) METHOD FOR MANUFACTURING SEPARATOR FOR FUEL CELL

(71) Applicant: TOYOTA JIDOSHA KABUSHIKI KAISHA, Toyota-shi (JP)

(72) Inventor: Yasuhiro NOBATA, Toyota-shi (JP)

(73) Assignee: TOYOTA JIDOSHA KABUSHIKI KAISHA, Toyota-shi (JP)

(21) Appl. No.: 16/752,915

(22) Filed: Jan. 27, 2020

(30) Foreign Application Priority Data
Feb. 4, 2019 (JP) 2019-018161

(51) Int. Cl. H01M 8/0258

(52) U.S. Cl. CPC H01M 8/0258

(57) ABSTRACT

Provided is a method for manufacturing a lighter separator for fuel cell that suppresses problems during the forming. The method forms a separator for fuel cell, and the separator includes a flow-channel part that defines a flow channel of fluid, and a seal part that surrounds the flow-channel part and seals the fluid. The method includes: an embedding step of embedding wire members in uncured thermosetting resin containing conductive particles; and a forming step of curing the thermosetting resin having the wire members embedded therein in a die to form the separator.

### CROSS REFERENCE TO RELATED APPLICATIONS

The present application claims priority from Japanese patent application JP 2019-018161 filed on Feb. 4, 2019, the content of which is hereby incorporated by reference into this application.

### BACKGROUND

### Technical Field

The present disclosure relates to a method for manufacturing a separator for fuel cell.

### Background Art

Conventionally inventions about a press-forming method of metal plate have been known (see JP 2018-094579 A). This conventional press-forming method aims to solve the problems about the press-forming of a separator for fuel cell. Specifically this method relates to the ridges of a material plate after a first forming step having a curved top face because of R-shaped (having a curved top) ridges of a die for the first forming step, and solves the difficulty of changing such a curved top face into a flat face by a secondary forming step (see the document, paragraphs 0002 to 0004, for example).

To solve the problem, this conventional press-forming method for metal plate includes a first pressing step and a second pressing step (see the document, claim 1, for example). The first pressing step press-forms a metal plate with a first preliminary-forming die and a second preliminary-forming die for preliminary forming to prepare a preliminary-formed metal plate having ridges and furrows extending like streaks. The second pressing step additionally press-forms the preliminary-formed metal plate with a first forming die and a second forming die for main forming.

This conventional press-forming method for metal plate includes the first pressing step as preliminary forming. This first pressing step brings flat tops of first ridges of the first preliminary-forming die in contact with the metal plate for pressing. This method allows the ridges of the preliminary-formed metal plate to have flat tops (ridges) as compared with the press-forming with a die having R-shaped ridges. The second pressing step of this method, which is main forming, brings flat bottoms of second furrows of the second forming die in contact with the metal plate. This allows the ridges of the metal plate after the main forming also to have flat tops (see the document, paragraphs 0006 to 0007, for example).

### SUMMARY

The need for lighter separators for fuel cell is increasing. To this end, separators for fuel cell made of resin are under study. When thermosetting resins, for example, are used as a material of separators for fuel cell, a core material is necessary to stabilize the shape of uncured thermosetting resin. A sheet material, such as metal foil, can be the option for such a core material, which is considerably thinner than the metal plate used in the conventional press-forming method as stated above.

Such a thin sheet material as the core material may interfere with the flowing of the uncured thermosetting resin in the die during curing of the thermosetting resin for forming, and this may cause the problems, such as creases, cracks and a local decrease of the thickness of the separator.

The present disclosure provides a method for manufacturing a lighter separator for fuel cell that suppresses the problems during the forming.

One aspect of the present disclosure is a method for manufacturing a separator for fuel cell. The method forms the separator including a flow-channel part that defines a flow channel of fluid, and a seal part that surrounds the flow-channel part and seals the fluid, and includes: an embedding step of embedding wire members in uncured thermosetting resin containing conductive particles; and a forming step of curing the thermosetting resin having the wire members embedded therein in a die to form the separator.

In the method for manufacturing a separator for fuel cell according to the above aspect, the embedding step may embed the wire members in a net-like fashion in the thermosetting resin.

The method for manufacturing the separator for fuel cell in the above aspect may further include: after the embedding step and before the forming step, a pre-curing step of pre-curing the thermosetting resin; and a conveying step of conveying the pre-cured thermosetting resin having the wire members embedded therein to the die.

In the method for manufacturing the separator for fuel cell in the above aspect, the conductive particles may be carbon particles, and the embedding step may place the thermosetting resin at a region corresponding to the flow-channel part so that a volume ratio of the carbon particles included in the thermosetting resin is 65% or more and 75% or less.

In the method for manufacturing the separator for fuel cell in the above aspect, the embedding step may place the thermosetting resin at a region corresponding to the seal part so that a volume ratio of the carbon particles included in the thermosetting resin is 20% or less.

The present disclosure provides a method for manufacturing a lighter separator for fuel cell that suppresses the problems during the forming.

### BRIEF DESCRIPTION OF THE DRAWINGS

FIG. 1 is a plan view showing an example of the configuration of a fuel cell;

FIG. 2 is an enlarged cross-sectional view of a major part of a fuel-cell stack including the lamination of the fuel cells shown in FIG. 1;

FIG. 3 is a flowchart of a method for manufacturing a separator for fuel cell according to one embodiment of the present disclosure;

FIG. 4 is a plan view of the uncured thermosetting resin after the embedding step shown in FIG. 3;

FIG. 5 is an enlarged cross-sectional view of the uncured thermosetting resin taken along the line V-V of FIG. 4; and

FIG. 6 schematically shows the thermosetting resin and the die after the conveying step shown in FIG. 3.

### DETAILED DESCRIPTION

The following describes one embodiment of a method for manufacturing a separator for fuel cell according to the present disclosure with reference to the drawings. The following firstly describes an example of a fuel cell including a separator for fuel cell and of a fuel-cell stack, and then describes one embodiment of a method for manufacturing a separator for fuel cell according to the present disclosure.

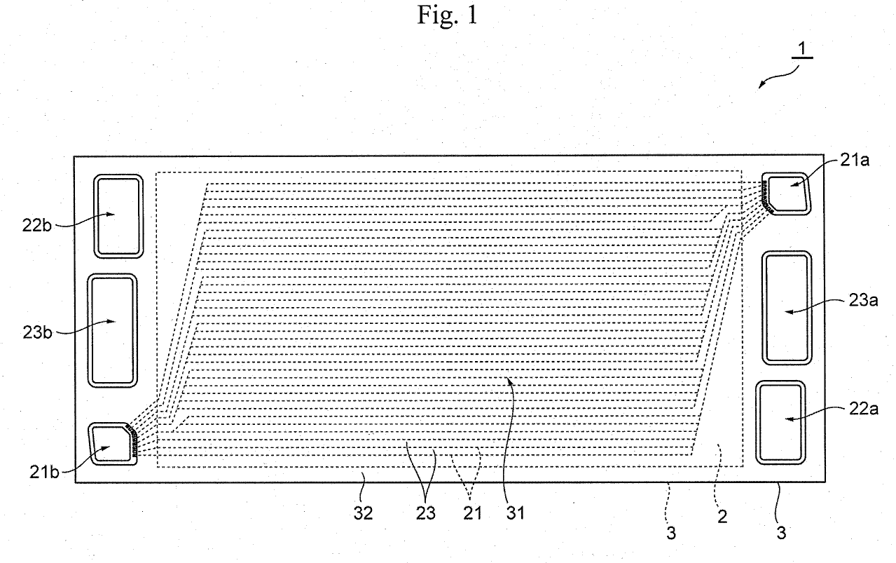

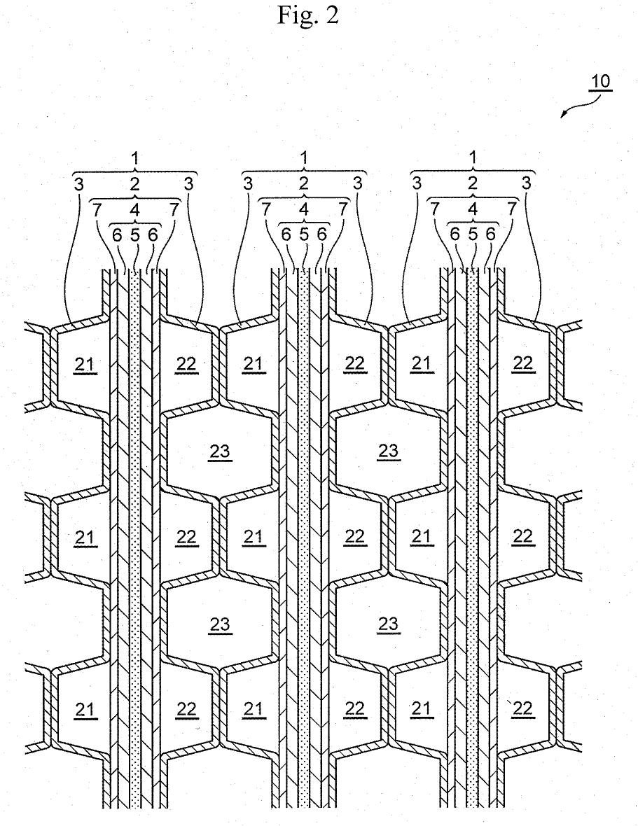

FIG. 1 is a plan view of a fuel cell (hereinafter simply called a “cell 1”). FIG. 2 is an enlarged cross-sectional view of a major part of a fuel-cell stack (hereinafter simply called a “stack 10”) that is the lamination of the cells 1 shown in FIG. 1. In one example, the cell 1 is a solid polymer fuel cell that generates electrical power through an electrochemical reaction between oxidant gas (e.g., air) and fuel gas (e.g., hydrogen). The cell 1 includes a membrane electrode & gas diffusion layer assembly (hereinafter abbreviated as “MEGA 2”) and separators 3 that are in contact with the MEGA 2 as a partition of the adjacent MEGAs 2.

The MEGA 2 is a power-generation part of the cell 1, and generates electrical power through an electrochemical reaction. The MEGA 2 is disposed between a pair of separators 3 and 3. The MEGA 2 includes a membrane electrode assembly (hereinafter abbreviated as “MEA 4”) integrated with gas diffusion layers 7 and 7 disposed on both sides of the MEA 4.

The MEA 4 includes an electrolyte membrane 5 and a pair of electrodes 6 and 6 that are joined to the electrolyte membrane 5 so as to sandwich the electrolyte membrane 5 therebetween. The electrolyte membrane 5 includes a proton-conductive ion-exchange membrane made of solid polymer. In another configuration of the cell 1 without the gas diffusion layers 7, the MEA 4 serves as the power-generation part of the cell 1.

The electrodes 6 may be made of a porous carbon material loaded with a catalyst, such as platinum. The electrode 6 disposed on one side of the electrolyte membrane 5 serves as an anode, and the electrode 6 on the other side serves as a cathode. In this stack 10, two adjacent cells 1 are disposed so that the anode electrode 6 of one of the cells 1 and the cathode electrode 6 of the other cell 1 are opposed.

The gas diffusion layers 7 include a conductive member having gas permeability, such as a carbon porous body, e.g., carbon paper or carbon cloth, or a metal porous body, e.g., metal mesh or foam metal.

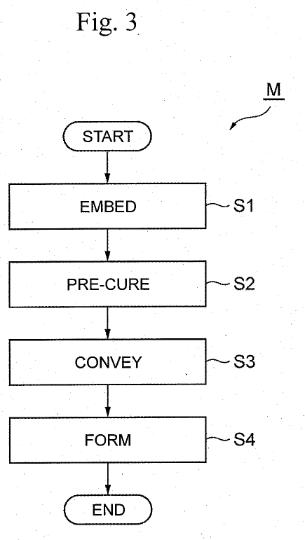

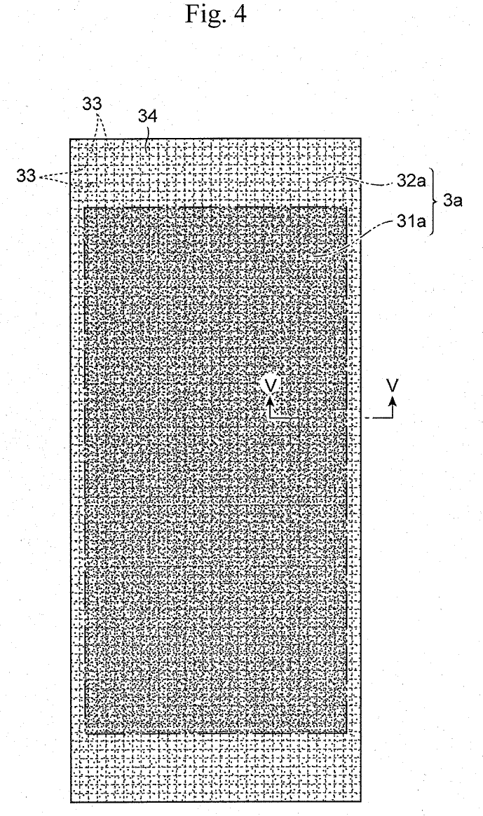

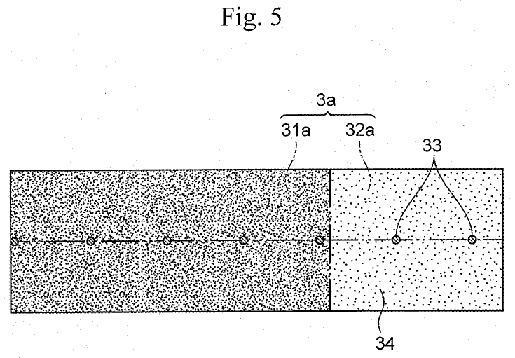

The separator 3 is a plate member made of conductive resin, and is manufactured by a method M for manufacturing a separator for fuel cell (see FIG. 3) described later. The separator 3 has the configuration such that wire members 33 are embedded in thermosetting resin 3a containing conductive particles 34 (see FIG. 4 and FIG. 5). Examples of the conductive particles 34 include carbon particles. Examples of the wire members 33 include metal wire, such as stainless steel (SUS) and titanium, resin wire, such as rayon, and inorganic wire, such as glass fiber. Examples of the thermosetting resin 3a include epoxy resin and phenol resin.

As shown in FIG. 1 and FIG. 2, the separator 3 has a flow-channel part 31 that defines flow channels 21, 22, and 23 of fluid, and a seal part 32 that surrounds the flow-channel part 31 to seal the fluid. FIG. 1 shows the flow channels 21 and 23 on the front surface side of the cell 1, and omits the flow channels 22 and 23 on the rear face side of the cell 1.

In one example, the flow-channel part 31 of the separator 3 has a corrugated pattern or has ridges and furrows in cross section shown in FIG. 2, and has a plurality of streak-like flow channels 21, 22 and 23 extending in the longitudinal direction of the cell 1 shown in FIG. 1 so as to traverse the power-generation part. In the flow-channel part 31, a pair of separators 3 and 3 of the cell 1 each have an inner face opposed to the MEGA 2 and an outer face on the other side of the MEGA 2, where the inner face is in contact with the gas diffusion layer 7 and the outer face is in contact with the outer face of the separator 3 of the adjacent cell 1.

With this configuration, the separator 3 on the anode side of the pair of separators 3 and 3 in each cell 1 defines the flow channel 21 for fuel gas with the MEGA 2, and the separator 3 on the cathode side defines the flow channel 22 for oxidant gas with the MEGA 2. Between the two adjacent cells 1, the outer face of the anode-side separator 3 of one of the cells 1 is in contact with the outer face of the cathode-side separator 3 of the other cell 1. This defines the flow channel 23 for refrigerant between the two adjacent cells 1.

More specifically each separator 3 has a corrugated pattern, and each wave shape of the corrugated pattern is an isosceles trapezoid. The isosceles trapezoid has a substantially flat top whose angles of both ends are equal, and the both ends are angular. That is, the shape of each separator 3 is substantially the same viewed from the inner face opposed to the MEGA 2 and from the outer face on the other side of the MEGA 2. Between the separators 3 and 3 as a pair in each cell 1, one of the separators 3 on the anode side has the tops in the corrugated pattern that are in planar contact with the gas diffusion layer 7 on the anode side of the MEGA 2, and the other separator 3 on the cathode side has the tops in the corrugated pattern that are in planar contact with the gas diffusion layer 7 on the cathode side of the MEGA 2.

As shown in FIG. 1, the seal part 32 of the separator 3 seals the outer periphery of the flow-channel part 31 of a pair of separators 3 and 3 of each cell 1, so as to avoid the leakage of gas flowing through the flow channels 21 and 22 inside of the pair of separators 3 and 3. More specifically the pair of separators 3 and 3 are in tight contact at the seal part 32, for example, where a seal member is disposed between the pair of separators 3 and 3 to seal the fluid.

Each cell 1 has manifold holes 21a and 21b and manifold holes 22a and 22b at the seal part 32. The manifold holes 21a and 21b communicate with the anode-side flow channel 21 between the pair of separators 3 and 3, and the manifold holes 22a and 22b communicate with the cathode-side flow channel 22 between the pair of separators 3 and 3. Each cell 1 has manifold holes 23a and 23b as well at the seal part 32. These manifold holes 23a and 23b are for supplying and discharging of refrigerant to the flow channel 23 outside of the pair of separators 3 and 3.

Each cell 1 having such a configuration receives fuel gas into the anode-side flow channel 21 of the MEGA 2 and receives oxidant gas into the cathode-side flow channel 22 of the MEGA 2, and generates an electrochemical reaction at the MEGA 2 to generate electrical power. The stack 10 outputs the electrical power generated at the plurality of cells 1 from both ends of these stacked cells 1 to supply the electrical power to the outside. These cells 1 in the stack 10 generate heat due to power generation, and refrigerant, such as cooling water, flowing through the flow channels 23 between the adjacent cells 1 and 1 takes the heat from the cells.

Next referring to FIG. 3, the following describes one embodiment of a method for manufacturing a separator for fuel cell according to the present disclosure. FIG. 3 is a flowchart showing an example of the steps of the method M for manufacturing a separator for fuel cell according to the present embodiment. Although the details are described later, the method M for manufacturing a separator for fuel cell of the present embodiment has the following major features.

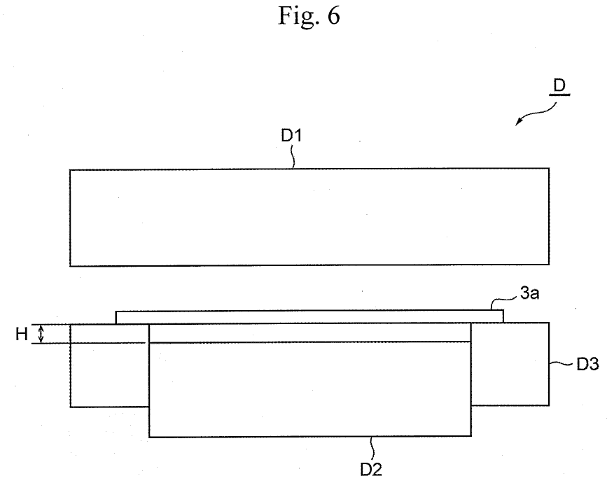

As shown in FIGS. 1 and 2, the method M for manufacturing a separator for fuel cell of the present embodiment forms a separator 3 having the flow-channel part 31 that defines the flow channels 21, 22 and 23 of fluid and the seal part 32 that surrounds the flow-channel part 31 to, seal the fluid, for example. This method M for manufacturing a separator for fuel cell includes: an embedding step S1 of embedding wire members 33 in uncured thermosetting resin 3a containing conductive particles 34 (see FIG. 4 and FIG. 5); and a forming step S4 of curing the thermosetting resin 3a having the wire members 33 embedded therein in a die D (FIG. 6) to form a separator 3. The following describes the method M for manufacturing a separator for fuel cell according to the present embodiment in more details.

In the example of FIG. 3, the method M for manufacturing a separator for fuel cell includes a pre-curing step (preliminary curing step) S2 and a conveying step S3 in addition to the embedding step S1 and the forming step S4 as stated above.

FIG. 4 is a plan view of uncured thermosetting resin 3a having the wire members 33 embedded therein at the embedding step S1. FIG. 5 is an enlarged cross-sectional view of the uncured thermosetting resin 3a taken along the line V-V of FIG. 4. The embedding step S1 embeds the wire members 33 in the uncured thermosetting resin 3a containing conductive particles 34 as stated above. More specifically the embedding step S1 includes a first applying step, a second applying step, a wire-member placing step, a third applying step and a fourth applying step, for example.

The first applying step applies uncured thermosetting resin 32a, which forms the seal part 32 of the separator 3 shown in FIG. 1, on a supporting substrate, for example. Specifically this step firstly prepares uncured thermosetting resin 32a in the slurry form that is kneaded with conductive particles 34. As stated above, examples of the conductive particles 34 include carbon particles, and examples of the thermosetting resin 32a include epoxy resin and phenol resin. In some embodiments, the volume ratio of the carbon particles in the thermosetting resin 32a, which is disposed in the region corresponding to the seal part 32 of the separator 3 shown in FIG. 1 at the embedding step S1, is 20% or less.

Next the first applying step applies the uncured thermosetting resin 32a containing the conductive particles 34 on the supporting substrate with an appropriate applicator, such as a die coater. This uncured thermosetting resin 32a is applied in the rectangular frame form corresponding to the shape of the seal part 32 shown in FIG. 1. That is the first applying step.

The second applying step follows the first applying step. The second applying step applies uncured thermosetting resin 31a, which forms the flow-channel part 31 of the separator 3 shown in FIG. 1, on the supporting substrate. Specifically this step firstly prepares uncured thermosetting resin 31a in the slurry form that is kneaded with conductive particles 34. As stated above, examples of the conductive particles 34 include carbon particles, and examples of the thermosetting resin 31a include epoxy resin and phenol resin. In some embodiments, the volume ratio of the carbon particles in the thermosetting resin 31a, which is disposed in the region corresponding to the flow-channel part 31 of the separator 3 shown in FIG. 1 at the embedding step S1, is 65% or more and 75% or less.

Next the second applying step applies the uncured thermosetting resin 31a containing the conductive particles 34 on the supporting substrate with an appropriate applicator, such as a die coater. This thermosetting resin 31a is applied inside of the thermosetting resin 32a in the rectangular frame form applied at the first applying step and at the region corresponding to the flow-channel part 31 shown in FIG. 1. That is the second applying step.

This embodiment describes the method of sequentially conducting the first applying step and the second applying step in the embedding step S1. In another embodiment, the first applying step may follow the second applying step or the first applying step and the second applying step may be conducted at the same time in the embedding step S1.

The wire-member placing step follows the first applying step and the second applying step. The wire-member placing step places the wire members 33, which is a core material of the separator 3, on the thermosetting resins 31a and 32a applied at the first applying step and the second applying step. Examples of the wire member include metal wire, such as stainless steel (SUS) and titanium, resin wire, such as rayon, and inorganic wire, such as glass fiber as stated above.

The plurality of wire members 33 on the thermosetting resin 3a of FIG. 4 include a plurality of wire members 33 extending in parallel from one end to the other end in the longitudinal direction of the thermosetting resin 3a and a plurality of wire members 33 extending in parallel from one end to the other end in the transverse direction of the thermosetting resin 3a. That is, in the example of FIG. 4, the wire-member placing step in the embedding step S1 places the plurality of wire members 33 in a net-like fashion on the thermosetting resins 31a and 32a to embed the plurality of wire members 33 in the thermosetting resin 3a. In this example, the wire members 33 are made of metal wire. The wire members 33 have a diameter of about 50 μm, for example, and the pitch of the wire members 33 is about 2 mm to 3 mm, for example.

The material, the diameter, the pitch and the arrangement of the wire members embedded in the thermosetting resin 3a at the embedding step S1 are not limited especially as long as the wire members keep the shape of the thermosetting resin 3a under a predetermined condition. In one example, a plurality of wire members 33 extending in parallel from one end to the other end only in the longitudinal direction of the thermosetting resin 3a may be embedded, or a plurality of wire members 33 extending in parallel from one end to the other end only in the transverse direction of the thermosetting resin 3a may be embedded. In any case, the wire-member placing step ends when the wire members 33 are placed on the thermosetting resins 31a and 32a applied at the first applying step and the second applying step.

The third applying step and the fourth applying step follow the wire-member placing step. The third applying step applies thermosetting resin 32a on the thermosetting resin 32a applied at the first applying step, on which the wire members 33 are placed at the wire-member placing step. The fourth applying step applies thermosetting resin 31a on the thermosetting resin 31a applied at the second applying step, on which the wire members 33 are placed at the wire-member placing step. The third applying step and the fourth applying step may be conducted similarly to the first applying step and the second applying step as stated above. These steps give the thermosetting resin 3a including the thermosetting resin 31a and the thermosetting resin 32a and having the wire members 33 embedded therein as shown in FIG. 4 and FIG. 5, and the embedding step S1 ends.

The pre-curing step S2 follows the embedding step S1, and pre-cures the thermosetting resin 3a before the forming step S4. Specifically the thermosetting resin 3a shown in FIG. 4 and FIG. 5 is heated at a temperature falling below the glass-transition temperature in a pre-heating furnace so that the thermosetting resin 3a is not cured completely but is partially cured to have a stable shape. When the conveying of the thermosetting resin 3a is not necessary after the embedding step S1 or when the thermosetting resin 3a has a stable shape without the pre-curing, the pre-curing step S2 can be omitted.

FIG. 6 schematically shows the thermosetting resin 3a and the die D after the conveying step S3. The conveying step S3 follows the embedding step S1, and, prior to the forming step S4, conveys the pre-cured thermosetting resin 3a having the wire members 33 embedded therein to the die D. Specifically the conveying step S3 conveys the pre-cured thermosetting resin 3a having the wire members 33 embedded therein with a suitable conveyor and places this at a predetermined position in the die D.

In one example, the die D has an upper die D1, a lower die D2, and a lifter D3. In one example, the upper die D1 and the lower die D2 are opposed to be relatively movable in the vertical direction, and define a cavity to form the flow-channel part 31 and the seal part 32 of the separator 3 as stated above. In one example, the lifter D3 has a supporting face in the rectangular frame form to support the outer periphery of the thermosetting resin 3a, and is disposed around the lower die D2 to be movable in the vertical direction. In one example, the conveying step S3 places the thermosetting resin 3a on the supporting face of the lifter D3. The configuration of the lifter D3 is one example, and the lifter can have any configuration.

At the conveying step S3, the temperature of the upper die D1 and the lower die D2 of the die D to place the thermosetting resin 3a increases to a temperature to heat the thermosetting resin 3a for curing, e.g., to about 180° C. This means that the temperature of the lifter D3 increases to about 150° C., for example. At the conveying step S3, the supporting face of the lifter D3 to support the thermosetting resin 3a is placed above the cavity-defining face of the lower die D2. At the conveying step S3, the height H from the cavity-defining face of the lower die D2 to the supporting face of the lifter D3 to place the thermosetting resin 3a is about 5 mm to about 10 mm, for example.

In one example, the forming step S4 includes a forming/curing step and a releasing step. The forming/curing step cures the thermosetting resin 3a having the wire members 33 embedded therein in the die D to form the separator 3 as stated above. Specifically as shown in FIG. 6, the thermosetting resin 3a, which is placed on the supporting face of the lifter D3 at the conveying step S3, is supported above the cavity-defining face of the lower die D2.

From this state, the lower die D2 and the upper die D1 are brought closer to close the die so as to store the thermosetting resin 3a in the cavity between the lower die D2 and the upper die D1. At this time, the supporting face of the lifter D3 is lowered to the cavity-defining face of the lower die D2. Then while closing the lower die D2 and the upper die D1 to form the thermosetting resin 3a, this step heats the thermosetting resin 3a with the heat of the upper die D1 and the lower die D2 for curing. That is the forming/curing step.

The releasing step follows the forming/curing step, and opens the upper die D1 and the lower die D2 and moves the lifter D3 upward. The step then cuts a part of the thermosetting resin 3a removed from the lower die D2 with a counter die and a punch to form the separator 3. Specifically the releasing step cuts the peripheral of the cured thermosetting resin 3a to form the seal part 32, and bores the manifold holes 21a, 21b, 22a, 22b, 23a, and 23b at the seal part 32. That is the releasing step. In this way the forming step S4 ends to form the separator 3 shown in FIG. 1 and FIG. 2.

The following describes the advantageous effects of the method M for manufacturing a separator for fuel cell according to the present embodiment.

As described above, the method M for manufacturing a separator for fuel cell of the present embodiment forms the separator 3 having the flow-channel part 31 that defines the flow channels 21, 22 and 23 of the fluid and the seal part 32 that surrounds the flow-channel part 31 to seal the fluid. This method M for manufacturing a separator for fuel cell includes: the embedding step S1 of embedding the wire members 33 in the uncured thermosetting resin 3a containing the conductive particles 34; and the forming step S4 of curing the thermosetting resin 3a having the wire members 33 embedded therein in the die D to form the separator 3.

The thermosetting resin 3a placed on the lifter D3 may be softened by heat transmitted from the lifter D3 or by radiation heat of the lower die D2 before the closing of the upper die D1 and the lower die D2. In such a case, the wire members 33 embedded in the thermosetting resin 3a function as the core material. The wire members 33 keep the shape of the thermosetting resin 3a, which can prevent the sagging of the thermosetting resin 3a before closing of the die and a contact of the thermosetting resin 3a with the lower die D2 before closing of the die. This enables precise placing of the thermosetting resin 3a at a predetermined position relative to the lower die D2, and so obtains the separator 3 mainly made of the thermosetting resin 3a that is light in weight as compared with metal while suppressing problems, such as creases, cracks, and a local decrease of the thickness.

As stated above, the embedding step S1 embeds the wire members 33 as the core material in the thermosetting resin 3a. This enlarges the flowable range of the thermosetting resin 3a during the curing for forming in the closed upper die D1 and lower die D2 at the forming step S4 as compared with the case of thermosetting resin having a sheet material, such as metal foil, as the core material. This therefore suppresses problems of the separator 3, such as creases, cracks, and a local decrease of the thickness and so obtains the separator 3 mainly made of the thermosetting resin 3a that is light in weight as compared with metal.

The method M for manufacturing a separator for fuel cell according to the present embodiment embeds the wire members 33 in a net-like fashion in the thermosetting resin 3a at the embedding step S1.

This improves the rigidity of the wire members 33 as the core material of the thermosetting resin 3a. This improves the effect of keeping the shape of uncured sheet-like thermosetting resin 3a placed in the die D as compared with the case of the wire members 33 just placed in parallel in one direction. When the thermosetting resin 3a is placed on the lifter D3, the thermosetting resin 3a may be softened due to heat of the die D. In this case also, the wire members in a net-like fashion more effectively prevent the sagging of the thermosetting resin 3a, and so more reliably prevent a contact of the thermosetting resin 3a with the lower die D2.

To form the thermosetting resin 3a to be ridges, the net-like wire members 33 are plastically deformed so that the mesh size of the net increases and so remains at optimum positions in the thermosetting resin 3a. To form the thermosetting resin 3a to be furrows, the net-like wire members 33 are plastically deformed so that the mesh size of the net decreases and so remains at optimum positions in the thermosetting resin 3a. In this way the net-like wire member 33 are deformed flexibly so as not to cause creases of the wire members 33 in the die D unlike the sheet-like core material, such as metal foil. Expansion and contraction of the wire members 33 in this way keeps the position of the wire members 33 embedded in the thermosetting resin 3a without exposing them to the surface of the thermosetting resin 3a during the curing of the thermosetting resin 3a.

This therefore suppresses problems of the separator 3, such as creases, cracks, and a local decrease of the thickness and so obtains the separator 3 mainly made of the thermosetting resin 3a that is light in weight as compared with metal. The strength of the separator 3 can be kept with the strength and the thickness of the cured thermosetting resin 3a.

The method M for manufacturing a separator for fuel cell of the present embodiment includes: after the embedding step. S1 and before the forming step S4, the pre-curing step S2 of pre-curing the thermosetting resin 3a; and the conveying step S3 of conveying the pre-cured thermosetting resin 3a having the wire members 33 embedded therein to the die D.

This allows the embedding step S1 of embedding the wire members 33 in the uncured thermosetting resin 3a to be conducted outside of the die D. The pre-curing step S2, which is the step of pre-curing the uncured thermosetting resin 3a having the wire members 33 embedded therein, enables the conveying of the pre-cured thermosetting resin to the die D at the conveying step S3. This improves the degree of freedom of the embedding step S1 and the forming step S4, and so improves the productivity of the separator 3.

In the method M for manufacturing a separator for fuel cell according to the present embodiment, the thermosetting resin 3a contains carbon particles as the conductive particles 34. As shown in FIG. 4 and FIG. 5, the embedding step S1 places the thermosetting resin 31a at the region corresponding to the flow-channel part 31 of the separator 3, and the volume ratio of the carbon particles included in the thermosetting resin 31a is 65% or more and 75% or less.

This keeps the contact resistance between the MEGA 2 and the separators 3 and 3 on the anode side and the cathode side in contact with the MEGA 2 as shown in FIG. 2 at an appropriate value. The contact resistance between the separator 3 on the anode side of one of the cells 1 between two adjacent cells 1 and 1 and the separator 3 on the cathode side of the other cell 1 also can have an appropriate value for the stack 10.

75% or less of the volume ratio of the carbon particles included in the thermosetting resin 31a keeps the strength of the flow-channel part 31 of the formed separator 3 and so prevents the dropping-off of the carbon particles. If the volume ratio of the carbon particles included in the thermosetting resin 31a exceeds 75%, this lowers the strength of the flow-channel part 31 of the formed separator 3 and so may cause the dropping-off of the carbon particles.

In the method M for manufacturing a separator for fuel cell of the present embodiment, the embedding step S1 places the thermosetting resin 32a at the region corresponding to the seal part 32 of the separator 3 as shown in FIG. 4 and FIG. 5, and the volume ratio of the carbon particles included in the thermosetting resin 32a is 20% or less.

This lowers the necessity of decreasing the contact resistance with the MEGAs 2 in each cell 1. At the seal part 32 of the separator 3 at a part that is not in contact with the separators 3 of the adjacent cell 1, the content of the carbon particles in the thermosetting resin 32a can be much lowered. This decreases the amount of the carbon particles in the thermosetting resin 3a of the separator 3, and so reduces the manufacturing cost of the separator 3.

That is a detailed description of the embodiment of the method for manufacturing a separator for fuel cell of the present disclosure, with reference to the drawings. The specific configuration of the present disclosure is not limited to the above-stated embodiment, and the design may be modified variously without departing from the spirits of the present disclosure. The present disclosure also covers such modified embodiments.

### DESCRIPTION OF SYMBOLS

3 Separator
3a Thermosetting resin
21 Flow channel
22 Flow channel
23 Flow channel
31 Flow-channel part
31a Thermosetting resin
32 Seal part
32a Thermosetting resin
33 Wire member
34 Conductive particle
D Die
M Method for manufacturing separator for fuel cell
S1 Embedding step
S2 Pre-curing step
S3 Conveying step
S4 Forming step

What is claimed is:

1. A method for manufacturing a separator for fuel cell, the method forming the separator including a flow-channel part that defines a flow channel of fluid, and a seal part that surrounds the flow-channel part and seals the fluid and comprising:
an embedding step of embedding wire members in uncured thermosetting resin containing conductive particles; and
a forming step of curing the thermosetting resin having the wire members embedded therein in a die to form the separator.

2. The method for manufacturing the separator for fuel cell according to claim 1, wherein the embedding step embeds the wire members in a net-like fashion in the thermosetting resin.

3. The method for manufacturing the separator for fuel cell according to claim 2, further comprising: after the embedding step and before the forming step,
a pre-curing step of pre-curing the thermosetting resin; and
a conveying step of conveying the pre-cured thermosetting resin having the wire members embedded therein to the die.

4. The method for manufacturing the separator for fuel cell according to claim 1, wherein the conductive particles are carbon particles, and
the embedding step places the thermosetting resin at a region corresponding to the flow-channel part so that a volume ratio of the carbon particles included in the thermosetting resin is 65% or more and 75% or less.

5. The method for manufacturing the separator for fuel cell according to claim 4, wherein the embedding step places the thermosetting resin at a region corresponding to the seal part so that a volume ratio of the carbon particles included in the thermosetting resin is 20% or less.
